(19) United States
(12) Patent Application Publication
(10) Pub. No.: US 2017/0178289 A1
(43) Pub. Date: Jun. 22, 2017

(54) METHOD, DEVICE AND COMPUTER-READABLE STORAGE MEDIUM FOR VIDEO DISPLAY

(71) Applicant: Xiaomi Inc., Beijing (CN)

(72) Inventors: Tao ZHANG, Beijing (CN); Pingze WANG, Beijing (CN); Shengkai ZHANG, Beijing (CN)

(73) Assignee: Xiaomi Inc., Beijing (CN)

(21) Appl. No.: 15/360,509

(22) Filed: Nov. 23, 2016

(30) Foreign Application Priority Data
Dec. 16, 2015 (CN) 201510946349.9

(51) Int. Cl. G06T 3/40; G06F 3/0488; H04N 5/232; G06F 3/0484

(52) U.S. Cl. CPC G06T 3/40; G06F 3/04845; G06F 3/0488; H04N 5/23293

(57) ABSTRACT

The present disclosure relates to a method, device and computer-readable storage medium for video display. The method includes detecting a first trigger action on a first screen area; determining a trigger position corresponding to the first trigger action; determining a first set of parameters of an observation window based on the trigger position, wherein the observation window is centered on the trigger position; generating a second screen area based on the first set of parameters of the observation window; enlarging the second screen area to a size of the first screen area; and displaying the enlarged second screen area in place of the first screen area.

### CROSS-REFERENCE TO RELATED APPLICATION

This application is based on and claims priority to Chinese Patent Application No. 201510946349.9, filed on Dec. 16, 2015, which is incorporated herein by reference in its entirety.

### FIELD

The present disclosure relates to the field of video processing, and more particularly, to a method, device and computer-readable storage medium for video display.

### BACKGROUND

With the improvement of cellular phone cameras, users record more and more videos using their smart phones. However, when a user plays a video directly in the smart phone, some details of scenes in the video are usually unclear due to size limitation of the screen of the smart phone. For example, when the user records a video that a baby is playing on the grass, and he or she wants to watch the baby's facial expressions when playing this video, if the percentage of the baby in the video screen is small, it's hard for the user to watch the baby's facial expressions clearly.

### SUMMARY

This Summary is provided to introduce a selection of aspects of the present disclosure in a simplified form that are further described below in the Detailed Description. This Summary is not intended to identify key features or essential features of the claimed subject matter, nor is it intended to be used to limit the scope of the claimed subject matter.

In order to solve the problem in related arts, a method, device and computer-readable storage medium for video display are provided by the present disclosure to enlarge a partial area of video content automatically.

Aspects of the disclosure provide a method for video display. The method includes detecting a first trigger action on a first screen area; determining a trigger position corresponding to the first trigger action; determining a first set of parameters of an observation window based on the trigger position, wherein the observation window is centered on the trigger position; generating a second screen area based on the first set of parameters of the observation window; enlarging the second screen area to a size of the first screen area; and displaying the enlarged second screen area in place of the first screen area.

When determining the first set of parameters of the observation window, the method also includes determining a duration of the first trigger action on the first screen area; and determining the first set of parameters of the observation window based on the duration.

When determining the first set of parameters of the observation window, the method also includes determining a rectangle area centered at the trigger position, wherein the rectangle area includes a first length and a first width; determining a first enlargement factor for the rectangle area based on the duration; and enlarging the rectangle area by the first enlargement factor to encompass the observation window centered at the trigger position.

When determining the first enlargement factor for the rectangle area, the method also includes obtaining a ratio corresponding to the duration from an enlargement factor chart that is used for recording the ratio corresponding to the duration of the first trigger action; and determining the first enlargement factor for the rectangle area based on the ratio.

The method also includes displaying the observation window on the first screen area; monitoring an enlargement of the observation window; and generating a prompt to stop the first trigger action when the observation window exceeds the first screen area.

When enlarging the second screen area, the method also includes determining a first display resolution of the first screen area and a second display resolution of the second screen area; determining a second enlargement factor for the second screen area based on the first display resolution and the second display resolution; and increasing a resolution of the second screen area from the second display resolution to the first display resolution by the second enlargement factor.

The method also includes detecting a second trigger action on the second screen area; and replacing the second screen area with the first screen area based on the second trigger action.

Aspects of the disclosure also provide a processor and a memory for storing instructions, which are executable by the processor. The processor is configured to detect a first trigger action on a first screen area; determine a trigger position corresponding to the first trigger action; determine a first set of parameters of an observation window based on the trigger position, wherein the observation window is centered on the trigger position; generate a second screen area based on the first set of parameters of the observation window; enlarge the second screen area to a size of the first screen area; and display the enlarged second screen area in place of the first screen area.

The processor is also configured to determine a duration of the first trigger action on the first screen area; and determine the first set of parameters of the observation window based on the duration.

The processor is also configured to determine a rectangle area centered at the trigger position, wherein the rectangle area includes a first length and a first width; determine a first enlargement factor for the rectangle area based on the duration; and enlarge the rectangle area by the first enlargement factor to encompass the observation window centered at the trigger position.

The processor is also configured to obtain a ratio corresponding to the duration from an enlargement factor chart that is used for recording the ratio corresponding to the duration of the first trigger action; and determine the first enlargement factor for the rectangle area based on the ratio.

The processor is also configured to display the observation window on the first screen area; monitor an enlargement of the observation window; and generate a prompt to stop the first trigger action when the observation window exceeds the first screen area.

The processor is also configured to determine a first display resolution of the first screen area and a second display resolution of the second screen area; determine a second enlargement factor for the second screen area based on the first display resolution and the second display resolution; and increase a resolution of the second screen area from the second display resolution to the first display resolution by the second enlargement factor.

The processor is also configured to detect a second trigger action on the second screen area; and replace the second screen area with the first screen area based on the second trigger action.

Aspects of the disclosure also provide a non-transitory computer-readable storage medium having stored therein instructions that, when executed by a processor of a device, causes the processor to perform a method for video display. The method includes detecting a first trigger action on a first screen area; determining a trigger position corresponding to the first trigger action; determining a first set of parameters of an observation window based on the trigger position, wherein the observation window is centered on the trigger position; generating a second screen area based on the first set of parameters of the observation window; enlarging the second screen area to a size of the first screen area; and displaying the enlarged second screen area in place of the first screen area.

It is to be understood that the above general description and the following detailed description are merely for the purpose of illustration and explanation, and are not intended to limit the scope of the protection of the disclosure.

### BRIEF DESCRIPTION OF THE DRAWINGS

The accompanying drawings, which are incorporated in and constitute a part of this specification, illustrate aspects consistent with the invention and, together with the description, serve to explain the principles of the invention.

FIG. 1A is a flow diagram illustrating a method for video display according to an exemplary aspect of the present disclosure;

FIG. 1B is one scene illustrating a method for video display according to an exemplary aspect of the present disclosure;

FIG. 1C is another scene illustrating a method for video display according to an exemplary aspect of the present disclosure;

FIG. 2 is a flow diagram illustrating how to determine a observation window according to a first exemplary aspect of the present disclosure;

FIG. 3 is a flow diagram illustrating a method for video display according to a second exemplary aspect of the present disclosure;

FIG. 4 is a flow diagram illustrating a method for video display according to a third exemplary aspect of the present disclosure;

FIG. 5 is a flow diagram illustrating a method for video display according to a fourth exemplary aspect of the present disclosure;

FIG. 6 is a block diagram illustrating a device for video display according to an exemplary aspect of the present disclosure;

FIG. 7A is a block diagram illustrating another device for video display according to an exemplary aspect of the present disclosure;

FIG. 7B is a block diagram illustrating a second determining sub-module according to the aspect of FIG. 7A;

FIG. 8 is a block diagram illustrating another device for video display according to an exemplary aspect of the present disclosure; and

FIG. 9 is a block diagram illustrating a device for video display according to an exemplary aspect of the present disclosure.

The specific aspects of the present disclosure, which have been illustrated by the accompanying drawings described above, will be described in detail below. These accompanying drawings and description are not intended to limit the scope of the present disclosure in any manner, but to explain the concept of the present disclosure to those skilled in the art via referencing specific aspects.

### DETAILED DESCRIPTION

Reference will now be made in detail to example aspects, examples of which are illustrated in the accompanying drawings. The following description refers to the accompanying drawings in which same numbers in different drawings represent same or similar elements unless otherwise described. The implementations set forth in the following description of example aspects do not represent all implementations consistent with the present disclosure. Instead, they are merely examples of devices and methods consistent with aspects related to the present disclosure as recited in the appended claims.

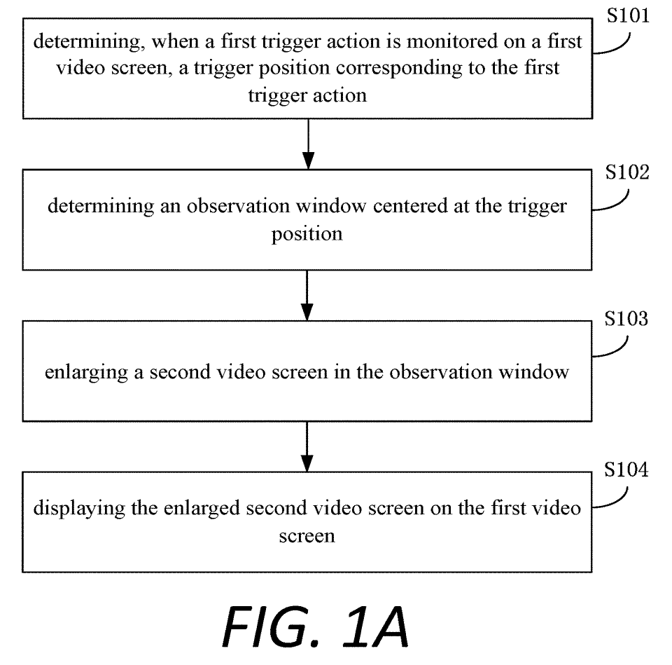

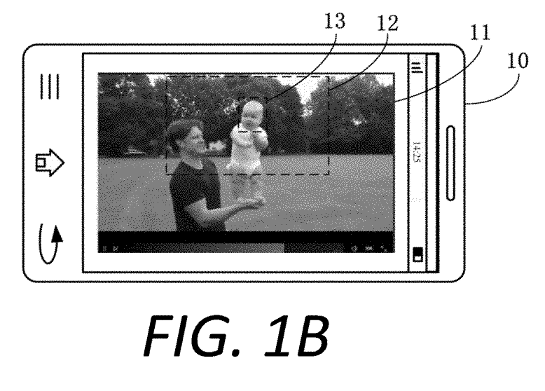

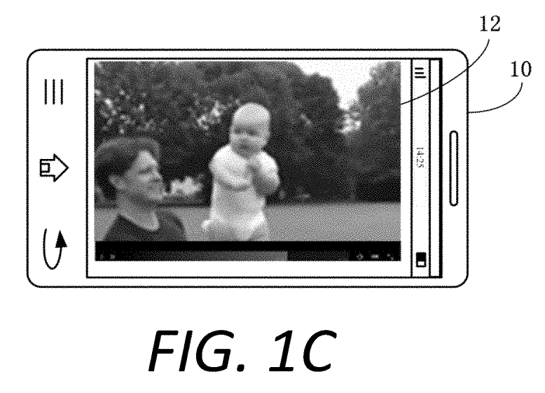

FIG. 1A is a flow diagram illustrating a method for video display according to an exemplary aspect; FIG. 1B is one scene illustrating a method for video display according to an exemplary aspect FIG. 1C is another scene illustrating a method for video display according to an exemplary aspect. The method for video display may be applied to an electronic device (e.g., smart phone, tablet) capable of playing video files and may include following steps S101-S104.

In step S101, a trigger position corresponding to the first trigger action is determined when a first trigger action is monitored on a first video screen having a first screen area.

In an aspect, the first trigger action may be a double-click action, a touch action and the like on the first video screen. In an aspect, the first video screen may be the original video screen of the video file currently played on a video-playing device. In another aspect, the first video screen may be live video screen collected by a camera device in real time. In an aspect, the trigger position may be represented by pixel coordinates on the first video screen, for example, the trigger position is at the pixel coordinate (400, 480) on the first video screen.

In step S102, an observation window centered at the trigger position is determined.

In an aspect, the size of the observation window may be determined by a period of time (e.g., duration) during which the first trigger action is being taken on the first video screen, for example, the longer the period of time, the bigger the size of observation window.

In step S103, a second video screen, having a second screen area, in the observation window is enlarged. The second screen area and an area of the observation window (e.g., first set of parameters) may be the same.

In step S104, the enlarged second video screen is displayed on the first video screen.

In an aspect, in order to prevent the second video screen exceeding the first video screen due to a big enlargement factor, the enlargement factor for the second video screen may be limited by the first display resolution of the first video screen, for example, the enlargement factor may be determined based on the first resolution and the second display resolution corresponding to the second video screen, so as to ensure the second video screen being within the scope of the first video screen.

In an example scenario, as shown in FIG. 1B, if the video-playing device 10 is playing a video currently, and a first trigger action taken on the facial area of the baby by the user is monitored on the first video screen 11, a rectangle area 13 (e.g., 50*40) centered at the trigger position of the first trigger action is determined with a predetermined length and width (e.g., the length is 50 pixels and the width is 40 pixels), and a first enlargement factor for the rectangle area 13 is usually determined based on the period of time during which the first trigger action is being taken on the first video screen 11, for example, if the user remains on the first video screen 11 for 10 seconds, the rectangle area 13 may be enlarged to the observation window 12, and the second video screen in the observation window 12 may be enlarged to the first display resolution corresponding to the first video screen 11, then the second video screen may be played, such that the user can clearly observe the baby's expressions.

In this aspect, by enlarging the second video screen in the observation window centered at the trigger position and displaying the enlarged second video screen in the first video screen, users may observe details of an interested partial area in the first video screen in real time after enlarging the partial area, which achieving the automatic enlargement of a partial area of video content, and obtaining the zoom function of lens, thereby users may concentrate on observing the video of the partial area they are more interested in.

In an aspect, determining the observation window centered at the trigger position may include: determining a period of time during which the first trigger action is being taken on the first video screen; and determining the observation window centered at the trigger position based on the period of time.

In an aspect, determining the observation window centered at the trigger position based on the period of time may include: determining a rectangle area centered at the trigger position with a predetermined length and width; determining a first enlargement factor for the rectangle area based on the period of time; and enlarging the rectangle area by the first enlargement factor to acquire the observation window centered at the trigger position.

In an aspect, determining the first enlargement factor for the rectangle area based on the period of time may include: looking up a ratio corresponding to the period of time in an enlargement factor chart, the enlargement factor chart is used for recording the ratio corresponding to the period of time during which the first video screen is triggered; and determining the first enlargement factor for the rectangle area based on the ratio.

In an aspect, the method for video display may further include: displaying the observation window on the first video screen; determining whether the observation window exceeds the first video screen in the process of enlarging the observation window; and prompting a user to stop triggering the first video screen when the observation window exceeds the first video screen.

In an aspect, enlarging a second video screen in the observation window may include: determining a first display resolution of the first video screen and a second display resolution of the second video screen; determining a second enlargement factor for the second video screen based on the first display resolution and the second display resolution; and enlarging the second video screen to the first display resolution corresponding to the first video screen by the second enlargement factor.

In an aspect, the method for video display may further include: monitoring whether there is a second trigger action on the second video screen; and controlling, when the second trigger action is monitored on the second video screen, a switch from the second video screen to the first video screen.

Reference will now be made in detail to subsequent aspects to illustrate how to achieve the video display.

The above described method provided in aspects of the present disclosure may enlarge a interested partial area in the first video screen to enable users to observe details of the partial region, which achieving the automatic enlargement of the partial area, and obtaining the zoom function of lens, thereby users may concentrate on observing the video of the partial region they are more interested in.

The technical solution provided by the present disclosure will be described in the following specific aspects.

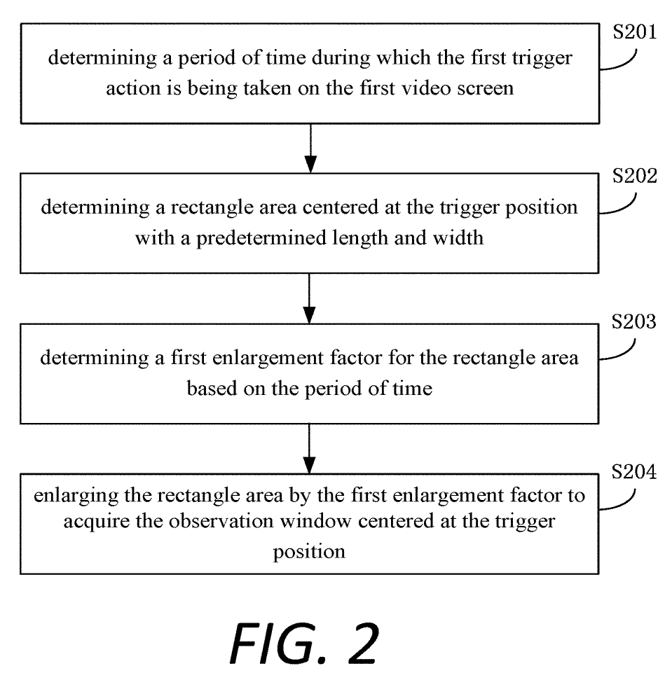

FIG. 2 is a flow diagram illustrating how to determine an observation window according to a first exemplary aspect. This aspect illustrates how to determine an observation window using the method described above in conjunction with FIG. 1B, as shown in FIG. 2, it may include following steps.

In step S201, a period of time during which the first trigger action is being taken on the first video screen is determined.

In an aspect, when the first trigger action is the double-click action, the period of time may be the time interval between the two click actions; and when the first trigger action is the touch action, the period of time may be the length of time that the first video screen is being touched.

In step S202, a rectangle area centered at the trigger position may be determined with a predetermined length and width.

In an aspect, the length and width of the rectangle area may be set in equal proportion to the length and width corresponding to the first display resolution of the first video screen. For example, if the first display resolution is 800*640, the preset number of pixels of the rectangle area in the length direction is 40 (that is, the length of the rectangle area), the present number of pixels of the rectangle area in the width direction is 32.

In step S203, a first enlargement factor for the rectangle area is determined based on the period of time.

In an aspect, a ratio corresponding to the period of time may be looked up in an enlargement factor chart, and the first enlargement factor may be determined based on the ratio. In an aspect, the enlargement factor chart may be provided by electronic device providers through lots of experiment tests.

In step S204, the rectangle area is enlarged by the first enlargement factor to acquire the observation window centered at the trigger position.

In an aspect, the period of time may be in direct proportion to the observation window, or the period of time and the size of the observation window may be determined based on a preset enlargement factor chart, the ratio corresponding to the period of time in the enlargement factor chart may be achieved by electronic device provider through lots of experiment tests. For example, if the period of time is 10 ms which corresponds to a ratio of 1.1, the rectangle area 13 may be enlarged 1.1 times; if the period of time is 20 ms which corresponds to a ratio of 3.2, the rectangle area 13 may be enlarged by 3.2 times, so as to obtain the observation window 12, the video screen in the observation window 12 need to be enlarged onto the whole video interface, that is, the area corresponding to the first video screen 11.

In the aspect, the first enlargement factor is determined based on the period of time, and the rectangle area is enlarged by the first enlargement factor to acquire the observation window centered at the trigger position, such that users may control the period of time based on their observation requirements so as to adjust the observation window, thereby users may adjust the size of the observation window flexibly, which bringing users an effect of playing the partial area that users is more interested in.

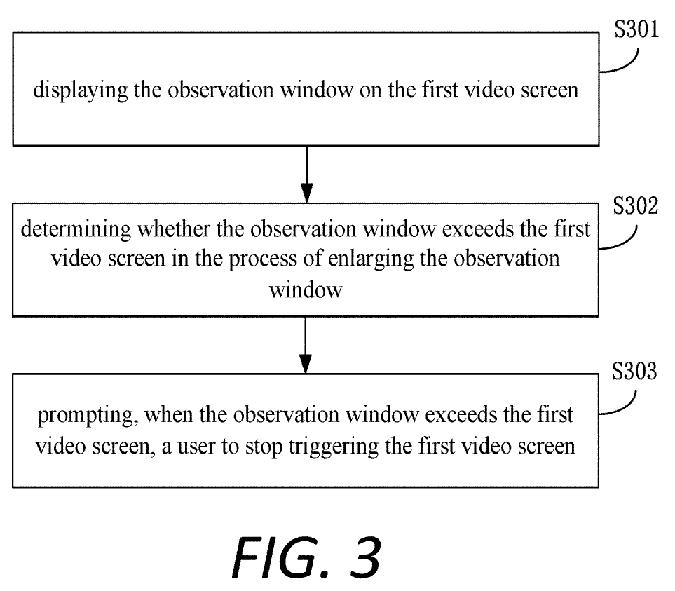

FIG. 3 is a flow diagram illustrating a method for video display according to a second exemplary aspect. This aspect illustrates how to display an observation window using the method described above in conjunction with FIG. 1B, as shown in FIG. 3, it may include following steps.

In step S301, the observation window is displayed on the first video screen.

As shown in FIG. 1B, the observation window 12 may be displayed as a rectangle block on the first video screen having a first set of parameters (e.g., height, width). In an aspect, the observation window 12 may be changed dynamically on the first video screen along with the change in the period of time. For example, the observation window 12 may expand from the rectangle area 13 which is regarded as the original block to outside along with the change in the period of time, and in this process, users may learn the display area of the observation window directly and control the video region required to be enlarged flexibly.

In step S302, whether the observation window exceeds the first video screen is determined in the process of enlarging the observation window.

In step S303, when the observation window exceeds the first video screen, a user is prompted to stop triggering the first video screen

In an aspect, if the period of time is too long, which leads to a too big enlargement factor so that the size of the observation window exceeds the first video screen, the user may be prompted to stop triggering the first video screen by a prompt box.

In the aspect, by displaying the observation window on the first video screen, users may learn the display area of the observation window directly and flexibly control the video area required to be enlarged. When the observation window exceeds the first video screen, users are prompted to stop triggering the first video, so as to ensure the efficiency of partial enlargement display to avoid users' misoperation disturbing the normal play of the first video screen.

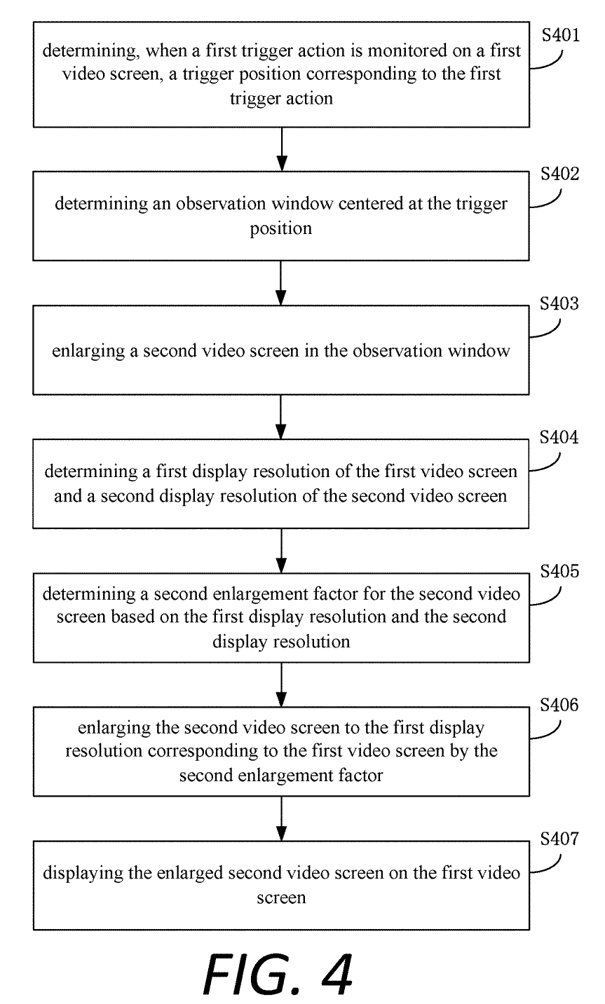

FIG. 4 is a flow diagram illustrating a method for video display according to a third exemplary aspect. This aspect illustrates how to enlarge the second video screen to the first display resolution corresponding to the first video screen using the method described above in conjunction with FIG. 1B and FIG. 1C, as shown in FIG. 4, it may include following steps.

In step S401, when a first trigger action is monitored on a first video screen, a trigger position corresponding to the first trigger action is determined.

In step S402, an observation window centered at the trigger position is determined.

In step S403, a second video screen in the observation window is enlarged.

Descriptions of steps S401 to S403 may refer to the related description of the above aspect in FIG. 1A, which will not be repeated herein.

In step S404, a first display resolution of the first video screen and a second display resolution of the second video screen are determined.

In step S405, a second enlargement factor for the second video screen is determined based on the first display resolution and the second display resolution.

In step S406, the second video screen is enlarged to the first display resolution corresponding to the first video screen by the second enlargement factor.

In step S407, the second video screen is displayed on the first video screen.

In an example scenario, as shown in FIG. 1B, the first display resolution of the first video screen 11 is 800*640, and the rectangle area is 40*32, the first enlargement factor acquired in the above described aspect is 4, then the second display resolution of the second video screen in the observation window 12 is 160*128, at this moment, the second video screen need to be enlarged to the first display resolution of the first video screen 11, the second enlargement factor is 800/160=5, that is, the second video screen need to be enlarged 5 times, so as to display the second video screen on the display area of the first video screen 11, the display result is shown as FIG. 1C.

In the aspect, the second enlargement factor for the second video screen is determined based on the first display resolution and the second display resolution, so as to enlarge the second video screen to the first display resolution corresponding to the first video screen by the second enlargement factor and play the second video screen, such that users may watch the second video screen in the enlarged observation window in the whole play interface. It should be ensured that the second video screen is enlarged with a proper ratio to avoid reducing visual aesthetics.

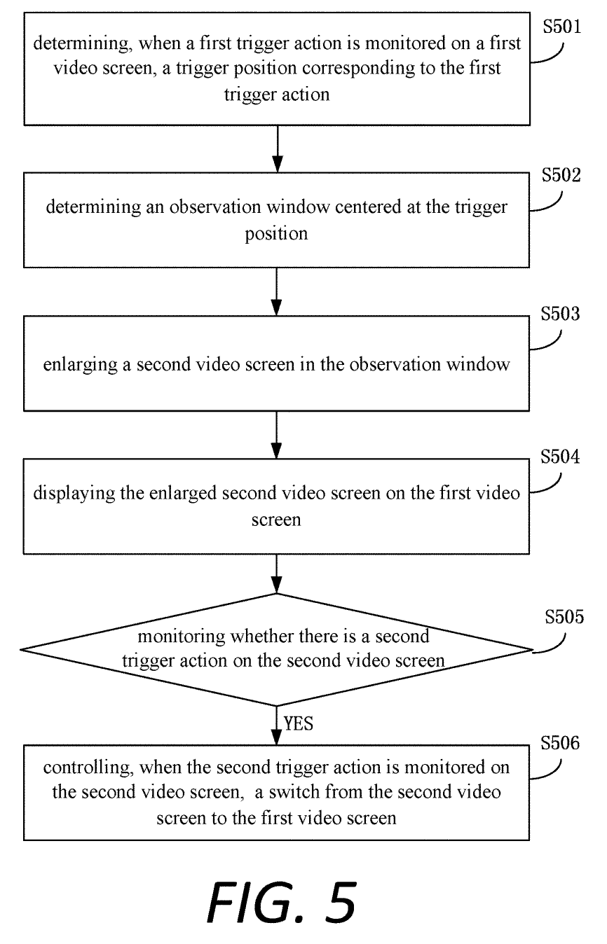

FIG. 5 is a flow diagram illustrating a method for video display according to a fourth exemplary aspect. This aspect illustrates how to switch the second video screen to the first video screen using the method described above in conjunction with FIG. 1B and FIG. 1C, as shown in FIG. 5, it may include following steps.

In step S501, when a first trigger action is monitored on a first video screen, a trigger position corresponding to the first trigger action is determined.

In step S502, an observation window centered at the trigger position is determined.

In step S503, a second video screen in the observation window is enlarged.

In step S504, the enlarged second video screen is displayed in the first video screen.

Descriptions of steps S501 to S504 may refer to the related description of the above aspect in FIG. 1A, which will not be repeated herein.

In step S505, whether there is a second trigger action is monitored on the second video screen, and if the second trigger action is monitored on the second video screen, perform step S506; if the second trigger action is not monitored, continue playing the second video screen.

In an aspect, the implementation of the second trigger action may refer to the implementation of the first trigger action, which will not be repeated herein.

In step S506, when the second trigger action is monitored on the second video screen, controlling a switch from the second video screen to the first video screen.

The second video screen 13 is merely the enlarged video screen of the video in the first video screen 11, in order to ensure users watching the first video screen 11 as normal, a second trigger action may be monitored on the second video screen 13. If the second trigger action is monitored, the video-playing device 10 may be controlled to switch from the second video screen to the first video screen 11.

In the aspect, when the second trigger action is monitored in the second video screen, a switch from the second video screen to the first video screen may be performed, and thus the switch between the partial enlarged second video screen and the original first video screen may be performed flexibly, to achieve the zoom function similar to lens in the real-time display process, which improving users' viewing experience.

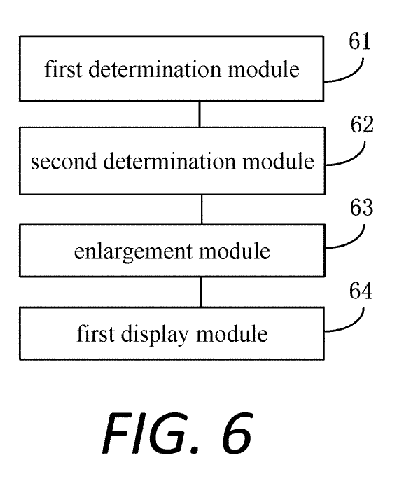

FIG. 6 is a block diagram illustrating a device for video display according to an exemplary aspect, as shown in FIG. 6, the device for video display may include: a first determination module 61 configured to determine, when a first trigger action is monitored on a first video screen, a trigger position corresponding to the first trigger action; a second determination module 62 configured to determine an observation window centered at the trigger position determined by the first determination module 61; an enlargement module 63 configured to enlarge a second video screen in the observation window determined by the second determination module 62; and a first display module 64 configured to display the second video screen enlarged by the enlargement module 63 on the first video screen.

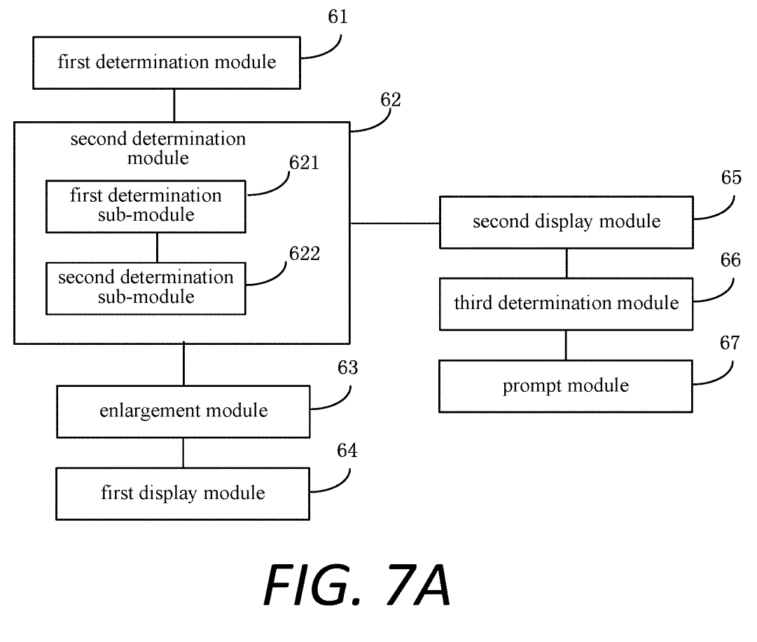

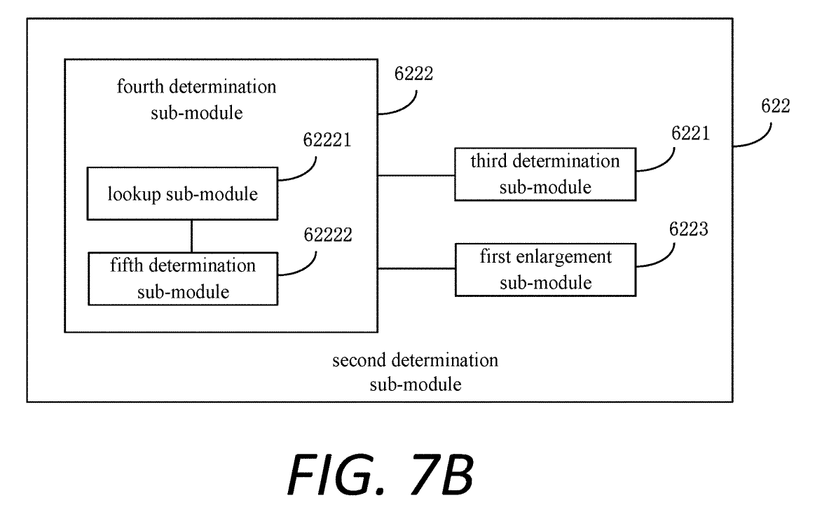

FIG. 7A is a block diagram illustrating another device for video display according to an exemplary aspect; FIG. 7B is a block diagram illustrating a second determining sub-module according to the aspect of FIG. 7A. As shown in FIG. 7A, it's on the basis of the aspect shown in FIG. 6, in an aspect, the second determination module 62 may include: a first determination sub-module 621 configured to determine a period of time during which the first trigger action is being taken on the first video screen; and a second determination sub-module 622 configured to determine the observation window centered at the trigger position based on the period of time determined by the first determination sub-module 621.

In an aspect, as shown in FIG. 7B, the second determination sub-module 622 may include: a third determination sub-module 6221 configured to determine a rectangle area centered at the trigger position with a predetermined length and width; a fourth determination sub-module 6222 configured to determine a first enlargement factor for the rectangle area determined by the third determination sub-module 6221 based on the period of time; and an first enlargement sub-module 6223 configured to enlarge the rectangle area by the first enlargement factor determined by the fourth determination sub-module 6222 to acquire the observation window centered at the trigger position.

In an aspect, the fourth determination sub-module 6222 may include: a lookup sub-module 62221 configured to look up a ratio corresponding to the period of time in an enlargement factor chart, the enlargement factor chart is used for recording the ratio corresponding to the period of time during which the first video screen is triggered; and a fifth determination sub-module 62222 configured to determine the first enlargement factor for the rectangle area based on the ratio looked up by the lookup sub-module 622221.

In an aspect, the device may further include: a second display module 65 configured to display the observation window determined by the second determination module 62 on the first video screen; a third determination module 66 configured to determine whether the observation window displayed by the second display module 65 exceeds the first video screen in the process of enlarging the observation window; and a prompt module 67 configured to prompt a user to stop triggering the first video screen when the third determination module 66 determines that the observation window exceeds the first video screen.

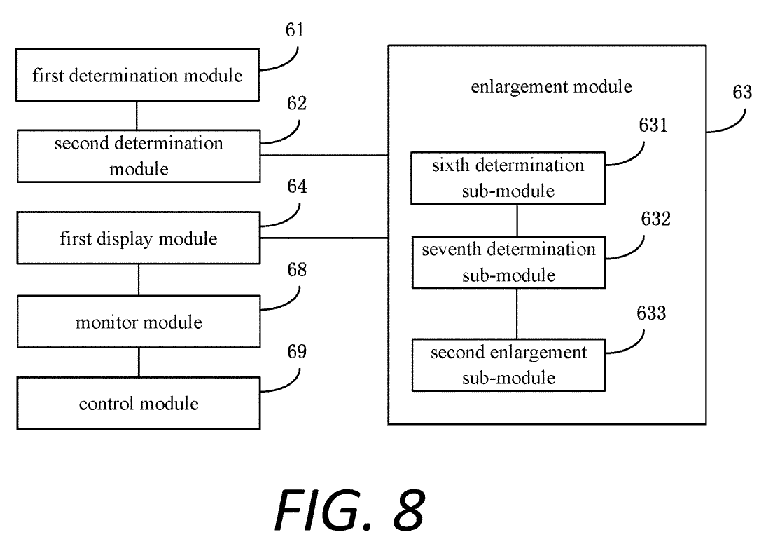

FIG. 8 is a block diagram illustrating another device for video display according to an exemplary aspect, as shown in FIG. 8, it's on the basis of the aspects shown in FIG. 6 or FIG. 7A, in an aspect, the enlargement module 63 may include: a sixth determination sub-module 631 configured to determine a first display resolution of the first video screen and a second display resolution of the second video screen; a seventh determination sub-module 632 configured to determine a second enlargement factor for the second video screen based on the first display resolution and the second display resolution determined by the sixth determination sub-module 631; and a second enlargement sub-module 633 configured to enlarge the second video screen to the first display resolution corresponding to the first video screen by the second enlargement factor determined by the seventh determination sub-module 632.

In an aspect, the device may further include: a monitor module 68 configured to monitor whether there is a second trigger action on the second video screen displayed by the first display module 64; and a control module 69 configured to control, when the second trigger action is monitored on the second video screen by the monitor module 68, a switch from the second video screen to the first video screen.

Implementations of the operations performed by the modules of the device in the above aspects have been described in the related aspects for method, which will not be repeated herein.

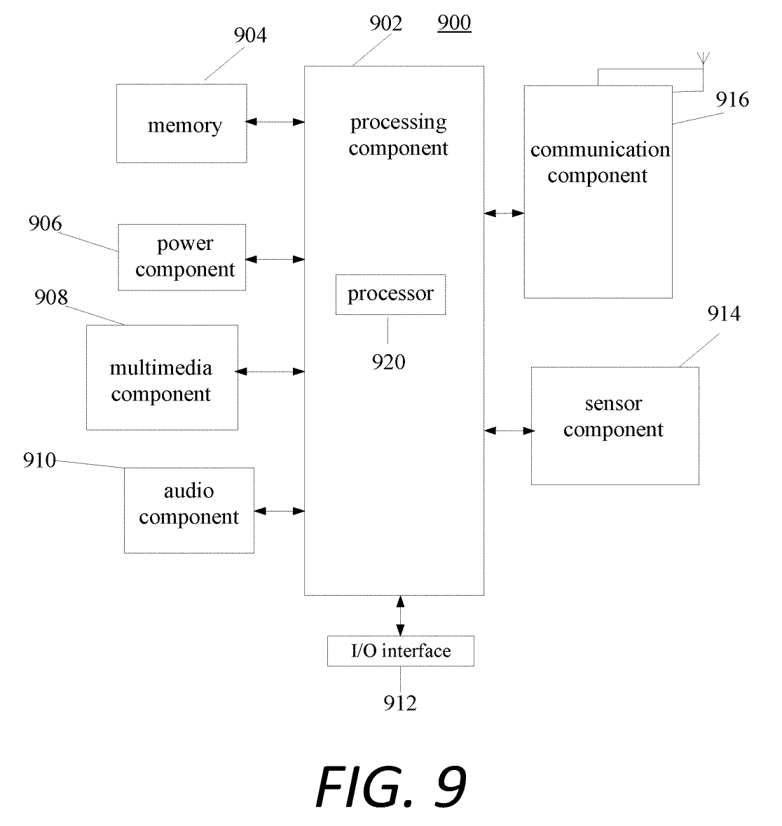

FIG. 9 is a block diagram illustrating a structure suitable for a device for video display according to an exemplary aspect. For example, the device 900 may be a mobile phone, a computer, a digital broadcast terminal, a message transceiver, a game console, a tablet device, a medical equipment, a fitness equipment, a personal digital assistant, and the like.

Referring to FIG. 9, the device 900 may include one or more of the following components: a processing component 902, a memory 904, a power component 906, a multimedia component 908, an audio component 910, an input/output (I/O) interface 912, a sensor component 914, and a communication component 916.

The processing component 902 typically controls overall operations of the device 900, such as the operations associated with display, telephone calls, data communications, camera operations, and recording operations. The processing component 902 may include one or more processors 920 to execute instructions to perform all or part of the steps in the above described methods. Moreover, the processing component 902 may include one or more modules which facilitate the interaction between the processing component 902 and other components. For instance, the processing component 902 may include a multimedia module to facilitate the interaction between the multimedia component 908 and the processing component 902.

The memory 904 is configured to store various types of data to support the operation of the device 900. Examples of such data may include instructions for any applications or methods operated on the device 4900, contact data, phonebook data, messages, pictures, video, etc. The memory 904 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 906 provides power to various components of the device 900. The power component 906 may include a power management system, one or more power sources, and any other components associated with the generation, management, and distribution of power in the device 900.

The multimedia component 908 includes a screen providing an output interface between the device 900 and the user. In some aspects, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also detect a period of time and a pressure associated with the touch or swipe action. In some aspects, the multimedia component 908 includes a front camera and/or a rear camera. The front camera and/or the rear camera may receive an external multimedia datum while the device 900 is in an operation mode, such as a photographing mode or a video mode. Each of the front camera and the rear camera may be a fixed optical lens system or have focus and optical zoom capability.

The audio component 910 is configured to output and/or input audio signals. For example, the audio component 910 includes a microphone (“MIC”) configured to receive an external audio signal when the device 900 is in an operation mode, such as a call mode, a recording mode, and a voice recognition mode. The received audio signal may be further stored in the memory 904 or transmitted via the communication component 916. In some aspects, the audio component 910 further includes a speaker to output audio signals.

The I/O interface 912 provides an interface between the processing component 902 and peripheral interface modules, such as a keyboard, a click wheel, buttons, and the like. The buttons may include, but are not limited to, a home button, a volume button, a starting button, and a locking button.

The sensor component 914 includes one or more sensors to provide status assessments of various aspects of the device 900. For instance, the sensor component 914 may detect an open/closed status of the device 900, relative positioning of components, e.g., the display and the keypad, of the device 900, a change in position of the device 900 or a component of the device 900, a presence or absence of user contact with the device 900, an orientation or an acceleration/deceleration of the device 900, and a change in temperature of the device 900.

The sensor component 914 may include a proximity sensor configured to detect the presence of nearby objects without any physical contact. The sensor component 914 may also include a light sensor, such as a CMOS or CCD image sensor, for use in imaging applications. In some aspects, the sensor component 914 may also include an accelerometer sensor, a gyroscope sensor, a magnetic sensor, a distance sensor, a pressure sensor, or a temperature sensor.

The communication component 916 is configured to facilitate communication, wired or wirelessly, between the device 400 and other devices. The device 900 can access a wireless network based on a communication standard, such as WiFi, 2G, or 3G, or a combination thereof. In one exemplary aspect, the communication component 916 receives a broadcast signal or broadcast associated information from an external broadcast management system via a broadcast channel. In one exemplary aspect, the communication component 916 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary aspects, the device 900 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary aspects, there is also provided a non-transitory computer-readable storage medium including instructions, such as the memory 904 including instructions executable by the processor 920 in the device 900 to perform the above-described methods. For example, the non-transitory computer-readable storage medium may be a ROM, a RAM, a CD-ROM, a magnetic tape, a floppy disc, an optical data storage device, and the like.

In exemplary aspects, there is also provided a non-transitory computer-readable storage medium including instructions that, when executed by a processor of a mobile terminal, enables the processor and/or the mobile terminal to perform the above-described method for video display.

It is noted that the various modules, sub-modules, units, and components in the present disclosure can be implemented using any suitable technology. For example, a module may be implemented using circuitry, such as an integrated circuit (IC). As another example, a module may be implemented as a processing circuit executing software instructions.

Other aspects of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. The specification and aspects are merely considered to be exemplary and the substantive scope and spirit of the disclosure is limited only by the appended claims.

It should be understood that the disclosure is not limited to the precise structure as described above and shown in the figures, but can have various modification and alternations without departing from the scope of the disclosure. The scope of the disclosure is limited only by the appended claims.

What is claimed is:

1. A method for video display, comprising:
detecting a first trigger action on a first screen area;
determining a trigger position corresponding to the first trigger action;
determining a first set of parameters of an observation window based on the trigger position, wherein the observation window is centered on the trigger position;
generating a second screen area based on the first set of parameters of the observation window;
enlarging the second screen area to a size of the first screen area; and
displaying the enlarged second screen area in place of the first screen area.

2. The method of claim 1, wherein determining the first set of parameters of the observation window includes:
determining a duration of the first trigger action on the first screen area; and
determining the first set of parameters of the observation window based on the duration.

3. The method of claim 2, wherein determining the first set of parameters of the observation window further includes:
determining a rectangle area centered at the trigger position, wherein the rectangle area includes a first length and a first width;
determining a first enlargement factor for the rectangle area based on the duration; and
enlarging the rectangle area by the first enlargement factor to encompass the observation window centered at the trigger position.

4. The method of claim 3, wherein determining the first enlargement factor for the rectangle area includes:
obtaining a ratio corresponding to the duration from an enlargement factor chart that is used for recording the ratio corresponding to the duration of the first trigger action; and
determining the first enlargement factor for the rectangle area based on the ratio.

5. The method of claim 1, further comprising:
displaying the observation window on the first screen area;
monitoring an enlargement of the observation window; and
generating a prompt to stop the first trigger action when the observation window exceeds the first screen area.

6. The method of claim 1, wherein enlarging the second screen area includes:
determining a first display resolution of the first screen area and a second display resolution of the second screen area;
determining a second enlargement factor for the second screen area based on the first display resolution and the second display resolution; and
increasing a resolution of the second screen area from the second display resolution to the first display resolution by the second enlargement factor.

7. The method of claim 1, further comprising:
detecting a second trigger action on the second screen area; and
replacing the second screen area with the first screen area based on the second trigger action.

8. A device for video display, comprising:
a processor;
a memory for storing instructions, which are executable by the processor, wherein the processor is configured to:
detect a first trigger action on a first screen area;
determine a trigger position corresponding to the first trigger action;
determine a first set of parameters of an observation window based on the trigger position, wherein the observation window is centered on the trigger position;
generate a second screen area based on the first set of parameters of the observation window;
enlarge the second screen area to a size of the first screen area; and
display the enlarged second screen area in place of the first screen area.

9. The device of claim 8, wherein the processor is further configured to:
determine a duration of the first trigger action on the first screen area; and
determine the first set of parameters of the observation window based on the duration.

10. The device of claim 9, wherein the processor is further configured to:
determine a rectangle area centered at the trigger position, wherein the rectangle area includes a first length and a first width;
determine a first enlargement factor for the rectangle area based on the duration; and
enlarge the rectangle area by the first enlargement factor to encompass the observation window centered at the trigger position.

11. The device of claim 10, wherein the processor is further configured to:
obtain a ratio corresponding to the duration from an enlargement factor chart that is used for recording the ratio corresponding to the duration of the first trigger action; and
determine the first enlargement factor for the rectangle area based on the ratio.

12. The device of claim 8, wherein the processor is further configured to:
display the observation window on the first screen area;
monitor an enlargement of the observation window; and
generate a prompt to stop the first trigger action when the observation window exceeds the first screen area.

13. The device of claim 8, wherein the processor is further configured to:
determine a first display resolution of the first screen area and a second display resolution of the second screen area;
determine a second enlargement factor for the second screen area based on the first display resolution and the second display resolution; and
increase a resolution of the second screen area from the second display resolution to the first display resolution by the second enlargement factor.

14. The device of claim 8, wherein the processor is further configured to:
detect a second trigger action on the second screen area; and
replace the second screen area with the first screen area based on the second trigger action.

15. A non-transitory computer-readable storage medium having stored therein instructions that, when executed by a processor of a device, causes the processor to perform a method for video display, the method comprising:
detecting a first trigger action on a first screen area;
determining a trigger position corresponding to the first trigger action;
determining a first set of parameters of an observation window based on the trigger position, wherein the observation window is centered on the trigger position;
generating a second screen area based on the first set of parameters of the observation window;
enlarging the second screen area to a size of the first screen area; and
displaying the enlarged second screen area in place of the first screen area.
